(19) United States
(12) Patent Application Publication
(10) Pub. No.: US 2009/0282167 A1
(43) Pub. Date: Nov. 12, 2009

(54) METHOD AND APPARATUS FOR BRIDGING

(75) Inventor: Wei Dai, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/503,693

(22) Filed: Jul. 15, 2009

Related U.S. Application Data
(63) Continuation of application No. PCT/CN2008/070226, filed on Jan. 31, 2008.

(30) Foreign Application Priority Data
Feb. 16, 2007 (CN) 200710079294.1

(51) Int. Cl. G06F 15/16; G06F 17/30

(52) U.S. Cl. 709/238; 707/3; 707/E17.014

(57) ABSTRACT

The present invention relates to a network and provides a method and apparatus for bridging. The method includes: storing the convergence values of the operation keys of a source node that represent the network node features into a Hash bucket table; performing convergence calculation on the operation keys that represent the destination node in an Ethernet data frame according to an entry convergence algorithm and obtaining the convergence values of the operation keys of the destination node in the Ethernet data frame; querying the Hash bucket table and forwarding table according to the convergence values of the operation keys of the destination node, and obtaining the forward information required for forwarding the Ethernet data frame; and forwarding the Ethernet data frame according to the forward information. With the present invention, the storage space occupied by the Hash bucket table may be decreased greatly, and the RAM resources are saved, while the pin resources of the chip are used reasonably.

The present application claims the benefit of Chinese Patent Application No. 200710079294.1, filed with the Chinese Patent Office on Feb. 16, 2007 and entitled “Method and Apparatus for Bridging”.

### FIELD OF THE INVENTION

The present invention relates to a network technology, and in particular, to a method and apparatus for bridging.

### BACKGROUND OF THE INVENTION

Bridging is a process of forwarding an Ethernet data frames according to media access control (MAC) address configured in the header of layer 2 of the Ethernet data frame.

A bridging scheme is a set of forwarding, learning and aging mechanisms that are established around a bridging table in compliance with the bandwidth requirements. Forwarding means upon receipt of an Ethernet data frame, the bridging module finds the destination port of the Ethernet data frame in the bridging table according to the destination MAC address and broadcast domain information in the Ethernet data frame, and then sends the Ethernet data frame to the destination port. Learning means upon receipt of an Ethernet data frames, the bridging module stores the source MAC address and the source port information of the Ethernet data frame in the bridging table correspondingly, to map the MAC address with the port as reference for forwarding data frame. Aging refers to aging some of the entries in the bridging table in a coming period.

In the prior art, the Hash algorithm is generally used to query the bridging table. The Hash function in the Hash algorithm refers to the mapping between the key set of the Hash algorithm and the address set of the Hash table. When the number of keys in the key set of the Hash algorithm is greater than the number of addresses in the address set of the Hash table, a conflict occurs. The Hash function may be properly designed to reduce the occurrence of conflicts. Nevertheless, this cannot avoid conflicts. In the Hash algorithm realized by the hardware, Hash bucket algorithm is generally used to solve conflicts. The Hash bucket algorithm is a method for storing the bridging table in a Hash bucket table.

In the bridging table, the MAC address and virtual local area network ID (VLAN ID) are used as keys of the Hash algorithm, which is also called Hash (key). In general, the depth of the bridging table is 64K, that is, there are 64K entries in the bridging table. As shown in Table 1, each entry contains MAC address, broadcast domain ID information (VLAN), forward information and so on, totaling up to 103 bits in size. Therefore, the size of the bridging table is about 6M (64K*103 bit). That is, about a 6-Mbit storage space is required to store such a bridging table.

TABLE 1
Entries in the Bridging Table

| Key of Hash | Valid | Aging | Static | MAC | VLAN | | Output Port | | |
|---|---|---|---|---|---|---|---|---|---|
| Algorithm | ID | ID | ID | Address | Information | Forward | Number | Forward | |
| (Hash (key)) | (V) | (Aged) | (Static) | (MAC) | (VLAN) | Opcode | (Port) | Information | Total |
| (64K) | (1) | (1) | (1) | (48) | (12) | (3) | (8) | (29) | (103) |

Obviously, the internal random access memory (RAM) of a chip cannot provide such a large storage space. Therefore, the bridging table can only be stored in an external RAM of the chip. If the bridge structure shown in FIG. 1 is adopted to implement the bridging scheme in the prior art, three external RAMs are required to store the bridging table. Besides, the ASIC chip should have 103 data lines connected to the external RAM. The three controllers (namely, ager, forwarder and learner) in the bridge structure as shown in FIG. 1 must access the bridging table in the external RAM of the chip through a synchronous static random access memory-controller (SSRAM_Control). Because capability performing continuously reading operation to the external RAMs is needed, and all bridge tables are saved in the HASH bucket, the bridging module that receives packets must access the whole Hash bucket to get the appropriate bridge table for forwarding and learning.

Distinctly, large storage space, such as an external RAM, is needed to store the bridge table in the Hash bucket. However, the bridge table stored in the HASH bucket will occupy additional resource of the external RAM and resource of pin of chip.

Further, because the whole bridging table is stored in the external RAM, there are high requirements for the bandwidth of the external RAM of the chip. But, because the whole Hash bucket must be accessed in the case of forwarding and learning, a certain bandwidth resources are wasted due to the low access efficiency.

To reduce the access bandwidth of the external RAM, the prior art designs the bridging table in a distributed structure. This divides the bridging table into a Hash bucket table and a forwarding table, with a mapping between the Hash bucket table and the forwarding table.

The Hash bucket table stores the keys, such as MAC address and VLAN ID, required by the match search in the case of forwarding. The forwarding table stores all the information except the keys. The Hash bucket table is stored in the internal RAM of the chip. The forwarding table is stored in the external RAM of the chip. The forwarding table contains forward information, aging information and static entry information.

However, the Hash bucket table stored in the internal RAM of the chip stores the key information for full march search, the resources in the internal RAM of the chip in the prior art are still highly consumed. If there are too many bridging table entries, this scheme is unlikely to work well.

Though the bridging table is divided into a Hash bucket table and a forwarding table, some information required by the learning operation may be saved in the forwarding table. For example, the aging information bit is stored in the forwarding table. There is a need to access the forwarding table when the learning operation requires the aging information bit. Therefore, to decide whether the learning operation is performed, it is still necessary to access the forwarding table.

In a word, the prior art wastes RAM resources, pin resources and bandwidth of the chip.

### SUMMARY OF THE INVENTION

The embodiments of the present invention provide a method and apparatus for bridging, so as to save RAM resources and pin resources of a chip.

The embodiments of the present invention provide the following technical scheme:

A method for bridging includes:

receiving a data frame;

obtaining operation keys in the data frame, wherein the operation keys represent the destination node;

performing convergence calculation on the operation keys with a first entry convergence algorithm, and obtaining a first convergence value of the operation keys;

querying a convergence table according to the convergence value, and obtaining a first physical address;

querying a forwarding table according to the first physical address, and obtaining forwarding information; and

forwarding the data frame according to the forwarding information.

An apparatus for bridging includes:

a receiving module for receiving data frame and obtaining operation keys in the data frame, wherein the operation keys represent the destination node feature of the data frame;

a first calculation module, adapted for performing convergence calculation on the operation keys with a first entry convergence algorithm, and obtaining convergence values corresponding to the operation keys;

a storage module, adapted for storing a convergence table and a forwarding table;

a querying module, adapted for obtaining a physical address from the convergence table according to the convergence table, and querying the forwarding table according to the physical address to obtain forwarding information; and

a forwarding module, adapted for forwarding the data frame according to the forwarding information.

As seen from the technical scheme provided by the embodiments of the present invention, the method and apparatus for bridging can solve the problems in the prior art. The method and apparatus use a small RAM storage space to store the convergence values of the operation keys of the source node in an Ethernet data frame and forward the Ethernet data frame according to the convergence values. This can save the RAM resources and use the pin resources of the chip reasonably.

### BRIEF DESCRIPTION OF THE DRAWINGS

FIG. 1 shows the bridge structure in the prior art;

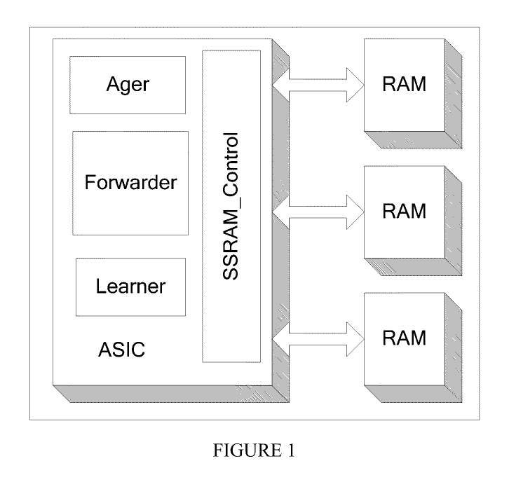

FIG. 2 shows the process of the technical scheme for bridging in an embodiment of the present invention;

FIG. 3 shows the bridge structure in an embodiment of the present invention;

FIG. 4 shows the structure of the apparatus for bridging in an embodiment of the present invention.

### DETAILED DESCRIPTION OF THE INVENTION

In an embodiment of the present invention, the bridging table is divided into a Hash bucket table, a forwarding table and an aging table. In another preferred embodiment of the present invention, the bridging table also can be divided into a Hash bucket table, and a forwarding table including information of aging table therein. In embodiments of the present invention, the Hash bucket table may be stored in the internal RAM or external RAM of a chip.

In an embodiment of the present invention, the aging table is used for indicating aging information, and may be stored in the internal RAM or external RAM of a chip. Further, because storing the aging table only occupies a small storage space, to reduce the access bandwidth of the external of the chip, the aging table is stored in the internal RAM of the chip. In the preferred embodiment of the invention, the aging procedure is the same as that in the prior art, so it is omitted here.

In an embodiment of the present invention, a method for bridging is supplied. In the embodiment of the present invention, the Hash bucket table stores convergence values of the operation keys that represent the network node features. Generally, these convergence values can be obtained by obtaining the convergence values of the operation keys that represent the source node (that is, the convergence values of the source keys corresponding to the source node) in an Ethernet data frame. The convergence values of the operation keys that represent the source node in the Ethernet data frame are obtained in dynamic learning mode or static configuration mode. When the former mode is used, there is a need to perform convergence calculation according to an entry convergence algorithm; when the latter mode is used, the convergence values can be directly configured according to a preset rule.

When the convergence values are stored, to get a first base address used for indicating the address of the Hash bucket in which the corresponding operation keys are stored, there is a need to perform calculation on the operation keys of the source node by using a first entry query algorithm. The first entry location where in the Hash bucket table the convergence values of the operation keys of the source node are stored is then determined according to the first base address. The convergence values of the operation keys of the source node are stored in the Hash bucket table according to the entry location.

A first convergence value is obtained by using the first entry convergence algorithm to perform convergence calculation operation keys that represent the destination node features in the first Ethernet data frame. The first convergence value may be used to query the Hash bucket table that stores the convergence values of the operation keys that represent the network node features.

Before querying the Hash bucket table that stores the convergence values of the operation keys that represent the network node features, the method further includes the following steps:

With the first entry convergence algorithm, performing convergence calculation on the operation keys that represent the source node features in the second received Ethernet data frame and obtain the second convergence value. Because the source node in the second Ethernet data frame is the same as the destination node in the first Ethernet data frame, the second convergence value presenting the source node features in the second received Ethernet data frame is the same as the first convergence value presenting the destination node features in the first Ethernet data frame.

With the first entry query algorithm, calculation is performed on the operation keys of the source node from which the second Ethernet data frame is sent, and the first base address is obtained.

The entry location where in the Hash bucket table the second convergence value is stored is determined according to the first base address; the second convergence value is stored into the Hash bucket table according to the entry location; and the learned information of the source node in the second Ethernet data frame is stored into the corresponding forwarding table.

The preceding first entry convergence algorithm may be a Hash convergence algorithm or any other convergence algorithm that is used to perform convergence calculation on the operation keys representing node feature. The first entry query algorithm may be a Hash query algorithm or any other query algorithm that is used to calculate the first base address corresponding to the operation keys of the source node.

The method provided in an embodiment of the present invention includes the following steps:

Step 1: Performing convergence calculation on the operation keys that represent the destination node (that is, the destination keys corresponding to the destination node) in the first Ethernet data frame by using the first entry convergence algorithm, and obtaining convergence values of the destination keys.

Step 2: Querying a convergence table and a forwarding table according to the convergence values of the destination keys, and obtaining the forward information required by the Ethernet data frame, wherein, in the embodiment of the invention, the convergence table is a Hash bucket convergence.

The step of querying the Hash bucket table is as follows: performing match search in the Hash bucket table according to the convergence values of the destination keys. Because there are convergence values of the operation keys that represent the network node features in the Hash bucket table, the corresponding destination node information can be obtained according to the related entry information in the Hash bucket table. The entry matching the convergence values can be found in the Hash bucket table through match search, and the physical address of the entry can be obtained.

The step of querying the forwarding table is as follows: obtaining the physical address of the entry in the forwarding table according to the physical address of the entry in the Hash table; and accessing the forwarding table according to the physical address of the entry in the forwarding table to obtain the matched forward information.

Step 3: Forwarding the Ethernet data frame according to the forward information.

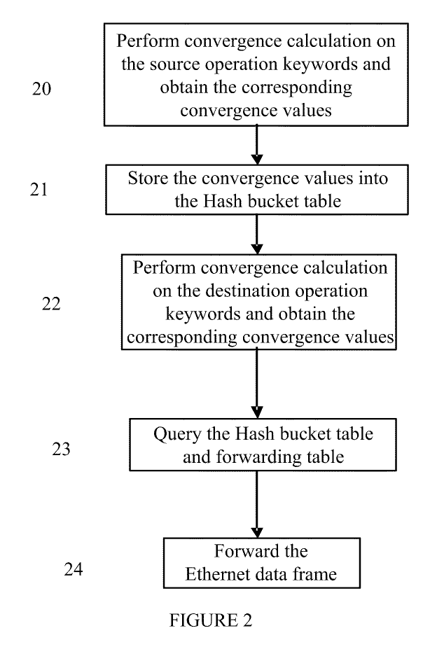

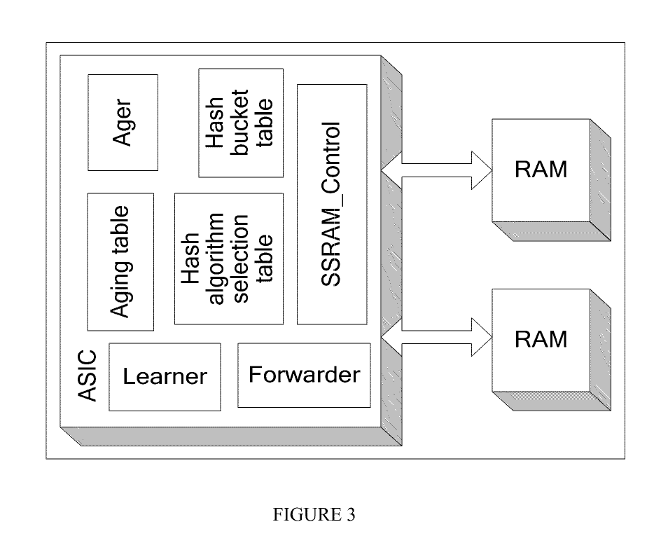

The following describes the technical scheme provided by an embodiment in the present invention in combination with FIG. 2. In the embodiment, the source operation key (recorded as the source key) in a received Ethernet data frame includes the source MAC address+VLAN ID. Besides, in the embodiment, the destination operation key (recorded as the destination key) in a received Ethernet data frame includes the destination MAC address+VLAN ID. In the embodiment the bridge related information is divided and respectively stored in a Hash bucket table, a forwarding table and an aging table, as shown in FIG. 3. The first entry convergence algorithm is used as the Hash entry convergence algorithm. The first entry query algorithm is used as the Hash query algorithm. The Hash bucket table is stored in the internal RAM of a chip.

The operation procedures in the technical scheme provided in the embodiment of the present invention include: learning operation procedure and forwarding operation procedure. The learning operation procedure includes step 20 and step 21. In the embodiment of the present invention, the learning operation is performed in dynamic mode. The forwarding operation procedure includes steps 22 to 24.

Step 20: Receiving an Ethernet data frame, and obtaining the source MAC address and VLAN ID from the Ethernet data frame; taking the source MAC address and VLAN ID as an operation key of the source node, that is, adopting the source MAC address and VLAN ID as a source key; calculating the source key by using the Hash entry convergence algorithm and the Hash entry query algorithm; obtaining the convergence value of the source key (recorded as result0) and the base address of the Hash bucket table corresponding to the source key (recorded as index0); proceeding to step 21.

The source key is often too huge, for example, MAC address plus VLAN ID. If such a huge key is directly stored in the Hash bucket table without any processing, a space of n (for example, n=60) bits is needed. In this case, storing in a Hash bucket table lots of key information takes up too much storage space in a RAM, which makes it difficult to store the Hash bucket table in an internal RAM of a chip. In contrast, if only convergence value of source key is stored in the Hash bucket table, the RAM space required by the Hash bucket table is greatly reduced. Besides, this makes it feasible to store the Hash bucket table in the internal RAM of the chip and finish the whole learning operation by accessing the internal RAM of the chip only, thus decreasing the access traffic or bandwidth requirements of the external RAM of the chip.

Step 21: After obtaining the convergence value and base address corresponding to the source key, accessing the Hash bucket table and check whether any information in the entry corresponding to the based address in the Hash bucket table matches the convergence value; if such information does not exist and the entry is null (that is, the entry is not occupied), storing the convergence value (result0) into the entry corresponding to the base address (index0) in the Hash bucket table; if an entry matches the convergence value, deciding whether to learn the source key according to the properties of the entry; if no information in the Hash bucket table matches the convergence value but the entry is not null (that is, the entry is occupied), neither storing the convergence value nor learning the source key.

Now the learning operation in the bridging procedure is complete. The following step 22 to step 24 describe the forwarding of the Ethernet data frame:

Step 22: (In the forwarding operation, there is a need to extract the destination MAC address+VLAN ID from the received Ethernet data frame as the destination key.)

Performing convergence calculation on the destination key by using the Hash entry convergence algorithm to obtain the corresponding convergence value result0′; performing match search in the Hash bucket table according to the result0′ to find the entry corresponding to the result0′ in the Hash bucket table; obtaining the physical address of the hit entry in the Hash bucket table; proceeding to step 23.

It is understandable that the physical addresses of entries in the Hash bucket table, forwarding table and aging table are relative to each other. Nevertheless, in the embodiment of the present invention, the three tables are stored in different RAMs. In this step, in the case of match search in the Hash bucket table according to the convergence value corresponding to the destination key, if there are hit entries in the Hash bucket table, the physical addresses of the hit entries can be obtained. Besides, the physical addresses of the corresponding entries in the forwarding table and aging table can be obtained according to the mapping among the physical addresses.

Step 23: Accessing the forwarding table stored in the external RAM of the chip according to the physical addresses of the hit entries, and obtaining the hit entries in the forwarding table; extracting the contents in the hit entries of the forwarding table, and obtaining the forward information required for forwarding the Ethernet data frame; proceeding to step 24.

It is understandable that the forward information may include the information of the destination port to which the Ethernet data frame is forwarded, that is, port information of the output port, or other information related to the output port. The embodiment of the present invention does not limit the contents of the forward information.

Step 24: Forwarding the Ethernet data frame according to the forward information.

The preceding procedures are the learning operation procedure and forwarding operation procedure in the technical scheme. The procedures may be performed at the same time in the embodiment of the present invention. Because the time required by the learning operation is shorter, the learning operation is generally complete earlier. This does not affect the ongoing forwarding operation. In the forwarding of other Ethernet data frames, it is necessary to determine the forward information required by the forwarding operation according to the results of the learning operation (for example, contents in the entries of the Hash bucket table). Nevertheless, the results of the learning operation are not stored in the Hash bucket table. In this case, the forwarder needs to broadcast the Ethernet data frame related to the forwarding operation. After the results of the learning operation are stored in the Hash bucket table, the Ethernet data frame is forwarded according to the entries in the Hash bucket table. The learning operation may be performed before or after the forwarding operation.

Based on the preceding procedures, the convergence calculation is performed on the operation keys in the Ethernet data frame. This greatly reduces the storage space occupied by the Hash bucket table and makes it possible to store the Hash bucket table in the internal RAM of the chip, thus greatly decreasing the occupancy of the RAM resources. Besides, the occupancy of pin resources can be decreased no matter whether the Hash bucket table is stored in the internal RAM or external RAM of the chip. If the Hash bucket table is separate from the forwarding table, storing the Hash bucket table in the internal RAM of the chip can greatly reduce the utilization of the pins and the bandwidth requirements for accessing the external RAM. This can save bandwidth and RAM resources and improve the bridging efficiency.

In the preceding procedures, if the results of keys in different Ethernet data frames obtained by using the entry algorithm (the Hash entry convergence algorithm or Hash entry query algorithm) are the same, a calculation result conflict occurs. For example, use the Hash entry convergence algorithm to perform calculation on the source MAC addresses+VLAN IDs in received Ethernet data frames 1 and 2 and obtain the convergence values result1 and result2 corresponding to the source MAC addresses+VLAN IDs in Ethernet data frames 1 and 2. If result1 is equal to result2, a calculation result conflict occurs.

When calculation is performed on different groups of source keys according to the Hash entry convergence algorithm and Hash entry query algorithm, the calculation results may conflict at the same time. This is because there is no original source key information in the Hash bucket table, making it difficult to detect the conflict. In this case, it is impossible to forward the related Ethernet data frames properly.

The technical scheme provided by an embodiment of the present invention solves the preceding calculation result conflict. An embodiment of the present invention can solve the calculation result conflict by using the software-aided learning operation or through hardware. Specifically, first judge whether the calculation results for different groups of source keys obtained according to the Hash entry convergence algorithm and the Hash entry query algorithm conflict at the same time. If yes, select another Hash entry convergence algorithm to avoid the conflict. If this method fails, report to the network administrator and notify users of replacing the source keys, such as MAC address.

The following example shows a method for bridging in accordance with an embodiment of the present invention, and the method includes:

performing calculation on source key 1 and source key 2 according to the first entry convergence algorithm and the first entry query algorithm;

obtaining a first convergence value and a first base address corresponding to the source key 1, and a second convergence value and a second base address corresponding to the source key 2;

when the first convergence value is equal to the second convergence value and the first base address is equal to the second base address at the same time, performing calculation on source key 1 and source key 2 with an second entry query algorithm, and obtaining a third convergence value corresponding to source key 1 and a fourth convergence value corresponding to source key 2;

if the third convergence value is not equal to the fourth convergence value, storing the mapping between the source keys and the second entry convergence algorithm, and storing the third convergence value into the entry corresponding to the first base address in the Hash bucket table and the fourth convergence value into the entry corresponding to the second base address in the Hash bucket table;

determining the corresponding entry convergence algorithm for destination key 1 corresponding to source key 1 and destination key 2 corresponding to source key 2 according to the mapping;

performing calculation on destination key 1 and destination key 2 according to the entry convergence algorithm, and obtaining a fifth convergence value corresponding to destination key 1 and a sixth convergence value corresponding to key 2;

performing match search in the Hash bucket table according to the fifth convergence value and the sixth convergence value, and obtaining physical addresses of the hit entries corresponding to the fifth convergence value and the sixth convergence value respectively;

querying a forwarding table according to the preceding physical addresses, and obtaining forward information 1 corresponding to the fifth convergence value and forward information 2 corresponding to the sixth convergence value;

forwarding the Ethernet data frames corresponding to source key 1 and key 2 according to forward information 1 and forward information 2 respectively;

wherein, in the embodiment, if the third convergence value is equal to the fourth convergence value, the method further comprises notifying the output ends of the Ethernet data frames corresponding to source key 1 and key 2 to change the source keys, such as source MAC address.

A method for bridging in accordance with a second exemplary embodiment of the present invention is supplied as below, and the method includes:

performing calculation on source key 1 and source key 2 according to the first entry convergence algorithm and the first entry query algorithm;

obtaining a first convergence value and a first base address corresponding to the source key 1, and a second convergence value and a second base address corresponding to the source key 2;

when the first convergence value is equal to the second convergence value and the first base address is equal to the second base address, performing calculation on source keys 1 and 2 with a second entry query algorithm;

obtaining a third base address corresponding to key 1 and a fourth base address corresponding to key 2;

if the third base address is not equal to the fourth base address, storing the first convergence value into the entry corresponding to the third base address in the Hash bucket table, and the second convergence value into the entry corresponding to the fourth base address in the Hash bucket table;

performing calculation on destination key 1 corresponding to source key 1 and on destination key 2 corresponding to source key 2, and obtaining a seventh convergence value corresponding to destination key 1 and an eighth convergence value corresponding to destination key 2;

performing match search in the Hash bucket table according to the seventh convergence value and the eighth convergence value, and obtaining the physical addresses of the hit entries corresponding to the seventh convergence value and the eighth convergence value;

querying a forwarding table according to the physical addresses, and obtaining forward information 3 corresponding to the seventh convergence value and forward information 4 corresponding to the eighth convergence value;

forwarding the Ethernet data frames corresponding to source key 1, and forwarding the key 2 according to forward information 3 and forward information 4;

wherein, if the third convergence value is equal to the fourth convergence value, notifying the output ends of the Ethernet data frames corresponding to source key 1 and key 2 to change the source keys, such as source MAC address.

A method for bridging in accordance with a third exemplary embodiment of the present invention is supplied, and the method includes:

performing calculation on source key 1 and source key 2 according to the first entry convergence algorithm and the first entry query algorithm;

obtaining a first convergence value and a first base address corresponding to the source key 1, and a second convergence value and a second base address corresponding to the source key 2;

when the first convergence value is equal to the second convergence value and the first base address is equal to the second base address, performing calculation on source keys 1 and 2 with a second entry query algorithm;

obtaining a third convergence value and a third base address corresponding to source key 1 and a fourth convergence value and the fourth base address corresponding to source key 2;

if the third convergence value and the fourth convergence value are not equal and the third base address and the fourth base address are not equal or they are not equal at the same time, storing the mapping between the source keys and the entry convergence algorithm, and storing the third convergence value into the entry corresponding to the third base address in the Hash bucket table and the fourth convergence value into the entry corresponding to the fourth base address in the Hash bucket table;

determining the corresponding entry convergence algorithm for destination key 1 corresponding to source key 1 and destination key 2 corresponding to source key 2 according to the mapping;

performing calculation on destination key 1 and destination key 2 according to the entry convergence algorithm, and obtaining the ninth convergence value corresponding to destination key 1 and the tenth convergence value corresponding to key 2;

performing match search in the Hash bucket table according to the ninth convergence value and the tenth convergence value, and obtaining the physical addresses of the hit entries corresponding to the ninth convergence value and the tenth convergence value;

querying a forwarding table according to the preceding physical addresses, and obtaining forward information 5 corresponding to the ninth convergence value and forward information 6 corresponding to the tenth convergence value;

forwarding the Ethernet data frames corresponding to source key 1 and key 2 according to forward information 5 and forward information 6;

wherein, if the third convergence value is equal to the fourth convergence value and the third base address is equal to the fourth base address at the same time, notifying the output ends of the Ethernet data frames corresponding to source key 1 and key 2 to change the source keys, such as source MAC address.

It is understandable that different Hash entry convergence algorithms are available for convergence calculation. Different entry convergence algorithms are stored in a Hash algorithm selection table, in which the Hash entry convergence algorithms may correspond to the Hash bucket tables one by one. That is, a Hash entry convergence algorithm corresponds to a Hash bucket table or multiple Hash bucket tables, or multiple Hash entry convergence algorithms correspond to a Hash bucket table. Besides, all the Hash entry convergence algorithms may correspond to a Hash bucket table only.

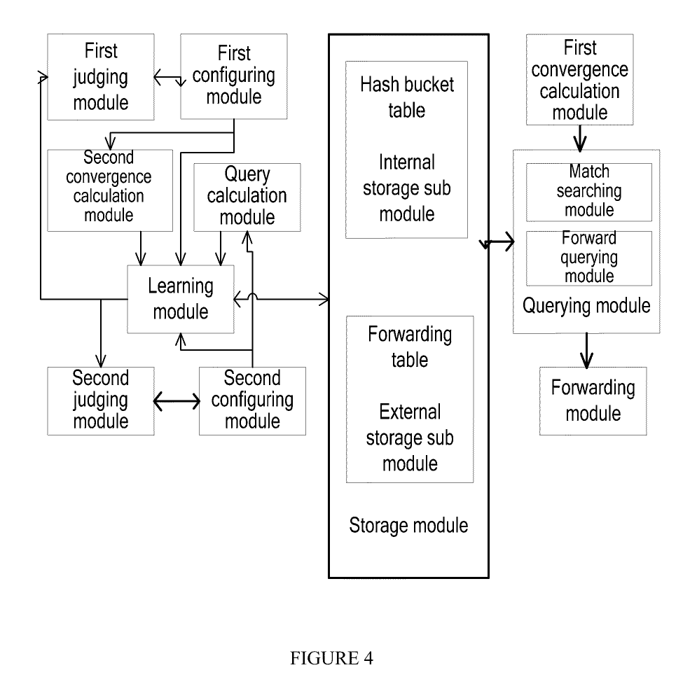

An embodiment of the present invention also provides an apparatus for bridging. FIG. 4 shows the structure of the apparatus. The apparatus includes a first convergence calculation module, a second convergence calculation module, a query calculation module, a storage module, a querying module, a forwarding module, a learning module, a first judging module and/or the second judging module, and a first configuring module and/or a second configuring module. In the embodiment of the present invention, the apparatus may include two groups of judging modules and configuring modules, that is, the first judging module and the first configuring module, and the second judging module and the second configuring module, or contain either of the two groups. The querying module includes a match querying module and a forward querying module. In the actual implementation of the apparatus, the first convergence calculation module and the second convergence calculation module may be implemented in one entity.

The first convergence calculation module is adapted to perform convergence calculation on operation keys (also called the destination keys) that represent destination node features in an Ethernet data frame, and obtain the convergence values corresponding to the operation keys of the destination node in the Ethernet data frame.

The second convergence calculation module is adapted to perform calculation on the operation keys of the source node in the Ethernet data frame according to an entry convergence algorithm, and obtain the convergence values corresponding to the operation keys of the source node in the Ethernet data frame.

The query calculation module is adapted to perform calculation on the operation keys of the source node in the received Ethernet data frame according to the entry query algorithm, and obtain a base address corresponding to the operation keys of the source node in the Ethernet data frame obtained by the second convergence calculation module.

The storage module is adapted to store a Hash bucket table and a forwarding table. The Hash bucket table is adapted to store the convergence values corresponding to the operation keys that represent the network node features. The storage module includes internal and external storage sub-modules. The internal storage sub-module is adapted to store the Hash bucket table and may further store an aging table. The external storage sub-module is adapted to store the forwarding table. The external storage sub-module is configured in an external RAM of a chip. The chip includes an application specific integrated circuit (ASIC) chip. The storage module is also adapted to store an algorithm selection table, which stores the entry convergence algorithm and entry query algorithm. The algorithm selection table corresponds to the Hash bucket table one by one. The aging table is adapted to store the aging information of the received Ethernet data frame. The Hash bucket table is adapted to store the convergence value and base address corresponding to the operation keys of the source node of the received Ethernet data frame. The forwarding table is adapted to store the forward information of the Ethernet data frame that is received through forwarding. The convergence value corresponding to the operation keys of the source node is obtained through the convergence calculation on the operation keys of the source node in the received Ethernet according to the entry convergence algorithm. The base address is obtained through the convergence calculation on the operation keys of the source node in the received Ethernet according to the entry query algorithm.

The learning module is adapted to determine the location of the entry where the convergence values of the operation keys of the source node are stored in the Hash bucket table according to the base address obtained by the query calculation module. It also stores the convergence values corresponding to the operation keys of the source node according to the location of the entry.

The querying module is adapted to query the Hash bucket table and forwarding table and obtain the forward information of the Ethernet data frame according to the convergence values of the operation keys of the destination node in the Ethernet data frame obtained by the convergence calculation module. The module includes a match querying module and a forward querying module. The match querying module is adapted to perform match query in the Hash bucket table according to the convergence values corresponding to the operation keys of the destination node that are obtained by the first convergence calculation module. The query result is the entries that match the convergence values corresponding to the operation keys of the destination node in the Hash bucket table. The forward querying module is adapted to obtain the physical addresses of the forwarding entries and the forward information of the Ethernet data frame according to the physical addresses of the matched entries that are obtained by the match querying module.

The forwarding module is adapted to forward the Ethernet data frame according to the forward information obtained by the querying module.

The first judging module is adapted to judge whether a conflict occurs when the learning module stores the convergence values of the operation keys of the source node that are obtained by the second convergence calculation module according to the base address obtained by the query calculation module.

When the first judging module judges that a conflict occurs, the first configuring module configures the second convergence calculation module to select a second entry convergence algorithm (different from the first entry convergence algorithm) and perform convergence calculation on the operation keys of the source node, and notifies the first judging module to make judgment. If the conflict still occurs, the first configuring module notifies the output end of the Ethernet data frame to change the operation keys of the source node. If no conflict occurs, the first configuring module notifies the learning module to store the mapping between the operation keys of the source node and the entry convergence algorithm. It also notifies the storage module to store the convergence values into the Hash bucket table.

The second judging module is adapted to judge whether a conflict occurs when the learning module stores the convergence values of the operation keys of the source node that are obtained by the second convergence calculation module according to the base address obtained by the query calculation module.

When the second judging module judges that a conflict occurs, the second configuring module configures the query calculation module to select a second entry query algorithm (different from the first entry query algorithm) and perform convergence calculation on the operation keys of the source node, and notifies the first judging module to make judgment. If the conflict still occurs, the second configuring module notifies the output end of the Ethernet data frame to change the operation keys of the source node. If no conflict occurs, the second configuring module notifies the learning module to store the convergence values.

It is understandable that the preceding first and second entry convergence algorithms and first and second entry query algorithms are not fixed algorithms and are used only for the purpose of describing the technical scheme of the present invention.

The technical scheme of the apparatus is the same as that of the method provided in the embodiment of the present invention, so it is omitted here.

In conclusion, the method and apparatus for bridging provided in the embodiment of the present invention perform convergence calculation on the operation keys of the source node in an Ethernet data frame and store the convergence values corresponding to the operation keys of the source node. This decreases the RAM space occupied by the information of the operation keys of the source node, thus achieving the objectives of reduction in occupancy of RAM resources and proper use of pin resources of the chip.

Although the technical scheme provided by the present invention has been described through some exemplary embodiments, the invention is not limited to such embodiments. The invention is intended to cover any technical scheme in any form that stores the convergence values of the operation keys of the source node in an Ethernet data frame into the Hash bucket table, obtains the convergence values of the destination keys in the Ethernet data frame by performing convergence calculation on the destination keys in the Ethernet data frame according to an entry convergence algorithm, obtains the forward information required for forwarding the Ethernet data frame by querying the Hash bucket table and forwarding table according to the convergence values of the destination keys, and forwards the Ethernet data frame according to the forward information.

Although the invention has been described through several exemplary embodiments, the invention is not limited to such embodiments. It is apparent that those skilled in the art can make various modifications and variations to the invention without departing from the spirit and scope of the present invention. The invention is intended to cover the modifications and variations provided that they fall in the scope of protection defined by the following claims or their equivalents.

What is claimed is:

1. A method for bridging, comprising:
receiving a data frame;
obtaining operation keys in the data frame, wherein the operation keys represent the destination node;
performing convergence calculation on the operation keys with a first entry convergence algorithm, and obtaining a first convergence value of the operation keys;
querying a convergence table according to the convergence value, and obtaining a first physical address;
querying a forwarding table according to the first physical address, and obtaining forwarding information; and
forwarding the data frame according to the forwarding information.

2. The method for bridging according to claim 1, wherein the convergence table is a Hash bucket table.

3. The method for bridging according to claim 1, wherein the method further comprises:
performing calculation on the operation keys with a first entry query algorithm, and obtaining a first base address for helping query the convergence table to obtain the forwarding information.

4. The method for bridging according to claim 3, wherein the first query algorithm is a Hash entry query algorithm.

5. The method for bridging according to claim 1, wherein the method further comprises:
obtaining source keys in the data frame, wherein the source keys in the data frame represent the source node which sends the data frame;
performing calculation on the source keys with the first entry convergence algorithm, and obtaining a second convergence value of the source key;
performing calculation on the source keys with a first entry query algorithm, and obtaining a second base address; and
storing the second convergence value of the source key in the convergence table according to the second base address.

6. The method for bridging according to claim 5, wherein the method further comprises:
storing information of the source keys in the forwarding table according to mapping between the convergence table and the forwarding table; and
according to the mapping between the convergence table and the forwarding table, storing a second physical address in the convergence table in the entry in which the information of the second convergence value is stored.

7. The method for bridging according to claim 5, wherein the method further comprises:
after obtaining the second convergence value and the second base address, checking if any conflicts occur in the convergence table;
if there is any conflicts occurring in the convergence table, performing calculation on the source keys with a second entry convergence algorithm and a second entry convergence algorithm for obtaining a third convergence value and a third base address; and
storing the third convergence value in the convergence table according to the third base address.

8. The method for bridging according to claim 1, wherein the forwarding information comprises a MAC address.

9. An apparatus for bridging, wherein the apparatus comprises:
a receiving module for receiving data frame and obtaining operation keys in the data frame, wherein the operation keys represent the destination node feature of the data frame;
a first calculation module, adapted for performing convergence calculation on the operation keys with a first entry convergence algorithm, and obtaining convergence values corresponding to the operation keys;
a storage module, adapted for storing a convergence table and a forwarding table;
a querying module, adapted for obtaining a physical address from the convergence table according to the convergence table, and querying the forwarding table according to the physical address to obtain forwarding information; and
a forwarding module, adapted for forwarding the data frame according to the forwarding information.

10. The apparatus for bridging according to claim 9, wherein the first query algorithm is a Hash entry query algorithm.

11. The apparatus for bridging according to claim 9, wherein the forwarding information comprises a MAC address.

12. The apparatus for bridging according to claim 9, wherein the apparatus for bridging further comprises a query calculation module, adapted for performing calculation on the operation keys according to a first entry query algorithm, and obtaining a base address for helping query the convergence table.

13. The apparatus for bridging according to claim 9, wherein the storage module comprises an internal storage sub-module and an external storage sub-module, wherein, the internal storage sub-module is adapted for storing the convergence table, and the external storage sub-module is configured in an external RAM of a chip of the apparatus and adapted for storing the forwarding table.

14. The apparatus for bridging according to claim 13, wherein the internal storage sub-module further stores an aging table adapted for storing aging information.

15. The apparatus for bridging according to claim 9, wherein the apparatus for bridging further comprises a learning module adapted for updating the convergence table according to convergence value of source keys in the data frame, and the convergence value represents features of a source node from which the data frame is sent.

16. The apparatus for bridging according to claim 15, wherein the convergence value of the operation keys of the source node is generated through performing calculation on the operation keys of the source node with the first entry convergence algorithm.

17. The apparatus for bridging according to claim 15, wherein the apparatus for bridging further comprises:
a first judging module, adapted for judging whether a conflict occurs when the learning module obtains the convergence value of the operation keys of the source node; if the conflict occurs, the convergence calculation module is configured to perform convergence calculation on the operation keys of the source node with a second entry convergence algorithm.

18. The apparatus for bridging according to claim 17, wherein the apparatus for bridging further comprises:
a query calculation module, adapted for performing second calculation on the operation keys of the source nodes with a first entry query algorithm, and obtaining second base address, wherein the learning module stores the convergence value of the operation keys of the source node in the convergence table according to the second base address; and
a second judging module, adapted for judging whether a conflict occurs after the second calculation is performed; when the conflict occurs after the second calculation is performed, the second judging module configures the query calculation module to perform calculation on the operation keys of the source node with a second entry query algorithm.

19. A method for bridging, comprising:
receiving a data frame;
obtaining operation keys in the data frame, wherein the operation keys represent the destination node;
performing convergence calculation on the operation keys with a first entry convergence algorithm, and obtaining a first convergence value of the operation keys;
querying a convergence table and a forwarding table according to the convergence and mapping between the convergence table and the forwarding table, and obtaining forwarding information;
forwarding the data frame according to the forwarding information.
